(19) United States
(12) Patent Application Publication
(10) Pub. No.: US 2026/0233527 A1
(43) Pub. Date: Aug. 13, 2026

(54) INKJET PRINTER AND METHOD FOR CONTROLLING JETTING HEAD

(71) Applicant: MIMAKI ENGINEERING CO., LTD., Nagano (JP)

(72) Inventor: Akihiro Tsukada, Nagano (JP)

(73) Assignee: MIMAKI ENGINEERING CO., LTD., Nagano (JP)

(21) Appl. No.: 19/106,615

(22) PCT Filed: Aug. 31, 2023
(86) PCT No.: PCT/JP2023/031682

§ 371 Date: Feb. 25, 2025

(30) Foreign Application Priority Data
Sep. 15, 2022 (JP) 2022-147458

(51) Int. Cl. B41J 2/165; B41J 2/15; B41J 25/00; B41J 29/00

(52) U.S. Cl. CPC B41J 2/16508; B41J 2/15; B41J 25/005; B41J 29/00

(57) ABSTRACT

There are provided an inkjet printer that can appropriately prevent a printing defect by reducing adhesion of minute ink to a nozzle surface, and a method for controlling a jetting head. The inkjet printer includes: a jetting head that performs ink jetting from a plurality of nozzle holes formed in a nozzle surface; a cap that is attachable on the nozzle surface of the jetting head; a head driving mechanism that moves the jetting head to a standby position where the cap is detachable and a printing position where printing is performed by acquiring print data; and a flushing control part that sequentially executes, for each group, a flushing operation of ink jetting to the cap from all of a plurality of the nozzle holes belonging to groups grouped in advance in a case where the jetting head moves to the standby position.

### TECHNICAL FIELD

The present invention relates to an inkjet printer and a method for controlling a jetting head.

### BACKGROUND ART

Conventionally, there is known an inkjet printer including a jetting head in which a plurality of nozzle holes are formed in a nozzle surface and a cap that is attached to the jetting head, in which ink droplets (hereinafter simply referred to as ink) jet toward the cap and flushing is performed during printing (see, for example, Patent Literature 1). This flushing is an operation of jetting ink from all the nozzle holes periodically (for example, for each scan in which the jetting head reciprocates once) during printing. Consequently, for example, ink thickened by adhering to circumferential edges (nozzle surface) of the nozzle holes can be removed, and ink accurately jets from the nozzle holes to a recording medium, and a fine image is printed.

### CITATION LIST

### Patent Literature

Patent Literature 1: Japanese Unexamined Patent Publication No. 2019-166792

### SUMMARY OF INVENTION

### Technical Problems

Incidentally, in the flushing operation described above, ink simultaneously jets from all the nozzle holes of the jetting head toward the cap. Therefore, turbulence occurs between ink droplets jetting from adjacent nozzle holes. In this case, if a distance (pitch) between the adjacent nozzle holes is equal to or longer than a predetermined distance (for example, about 500 um), the turbulence is negligible. However, if the distance between the nozzle holes is, for example, shorter than 200 um, the turbulence becomes strong. Therefore, the turbulence generated between the ink droplets causes fine ink droplets referred to as mist to adhere to the nozzle surface and the like, and there is room for improvement in preventing a printing defect of an image as appropriate.

The present invention has been made in view of the above description, and an object thereof is to provide an inkjet printer that can appropriately prevent a printing defect by reducing adhesion of minute ink to a nozzle surface, and a method for controlling a jetting head.

### Solutions to Problems

According to the present invention, there is provided an inkjet printer including: a jetting head that performs ink jetting from a plurality of nozzle holes formed in a nozzle surface; a cap that is attachable on the nozzle surface of the jetting head; a head driving mechanism that moves the jetting head to a standby position where the cap is detachable and a printing position where printing is performed by acquiring print data; and a flushing control part that sequentially executes, for each group, a flushing operation of ink jetting to the cap from all of a plurality of the nozzle holes belonging to groups grouped in advance in a case where the jetting head moves to the standby position.

In the inkjet printer, the jetting head has a configuration in which a plurality of nozzle rows are arranged in a main scanning direction, the plurality of nozzle rows having the plurality of nozzle holes arranged in a sub scanning direction orthogonal to the main scanning direction in which the jetting head moves, and the flushing control part defines each of the groups which includes every certain number of nozzle holes in at least one nozzle row, and executes a flushing operation for each group.

In the inkjet printer, the jetting head has a configuration in which a plurality of nozzle rows are arranged in a main scanning direction, the plurality of nozzle rows having the plurality of nozzle holes arranged in a sub scanning direction orthogonal to the main scanning direction in which the jetting head moves, and the flushing control part groups the individual nozzle holes adjacent to each other in the main scanning direction or the sub scanning direction into separate groups.

According to the present invention, there is provided a method for controlling a jetting head in an inkjet printer including a jetting head that performs ink jetting from a plurality of nozzle holes formed in a nozzle surface, a cap that is attachable on the nozzle surface of the jetting head, and a head driving mechanism that moves the jetting head to a standby position where the cap is detachable and a printing position where printing is performed by acquiring print data, the method including: a moving step of moving the jetting head to the standby position; and a flushing step of sequentially executing, for each group, a flushing operation of ink jetting to the cap from all of a plurality of the nozzle holes belonging to groups grouped in advance.

In the method for controlling a jetting head, the inkjet printer further includes a flushing control part, and the jetting head has a configuration in which a plurality of nozzle rows are arranged in a main scanning direction, the plurality of nozzle rows having the plurality of nozzle holes arranged in a sub scanning direction orthogonal to the main scanning direction in which the jetting head moves.

The method for controlling a jetting head further includes a step of grouping the individual nozzle holes adjacent to each other in the main scanning direction or the sub scanning direction into separate groups by the flushing control part, in which, in the flushing step, jetting is not performed at the same timing from the nozzle holes adjacent in the main scanning direction or the sub scanning direction.

### Effect of the Invention

According to the present invention, since adhesion of minute ink to a nozzle surface is reduced, a printing defect can be prevented as appropriate.

### BRIEF DESCRIPTION OF THE DRAWINGS

FIG. 1 is a schematic configuration diagram of an inkjet printer according to an embodiment of the present invention.

FIG. 2 is a plan view illustrating an example of a nozzle surface of a jetting head illustrated in FIG. 1.

FIG. 3 is a partial cross-sectional view taken along line A-A of FIG. 2.

FIG. 4 is a schematic diagram illustrating an example of a cleaning mechanism.

FIG. 5 is a flowchart illustrating an operation procedure of a method for controlling the jetting head.

FIG. 6 is a view schematically illustrating whether jetting is performed from nozzle holes in a flushing operation.

FIG. 7 is a view schematically illustrating whether jetting is performed from the nozzle holes in the flushing operation.

FIG. 8 is a view schematically illustrating whether jetting is performed from the nozzle holes in the flushing operation.

FIG. 9 is a view schematically illustrating whether jetting is performed from the nozzle holes in the flushing operation.

### DESCRIPTION OF EMBODIMENTS

Hereinafter, embodiments of an inkjet printer and a method for controlling a jetting head according to the present invention will be described with reference to the drawings. Note that the invention is not limited to the embodiments. In addition, configurational elements in the following embodiments include a configurational element with which one of the configurational elements can be easily replaced by those skilled in the art or a configurational element that is substantially the same as one the configurational elements.

In the present embodiment, directions in the drawings will be described using an XYZ coordinate system. In the XYZ coordinate system, a plane parallel to a floor surface on which the inkjet printer is installed is an XY plane. In the XY plane, a transport direction of a recording medium 2 to be described below is referred to as an X direction, and a direction orthogonal to the X direction on the XY plane is referred to as a Y direction. In addition, a direction perpendicular to the XY plane is referred to as a Z direction. In each of the X direction, the Y direction, and the Z direction, it is assumed that a direction of an arrow in the drawing is a +direction, and a direction opposite to the direction of the arrow is a-direction.

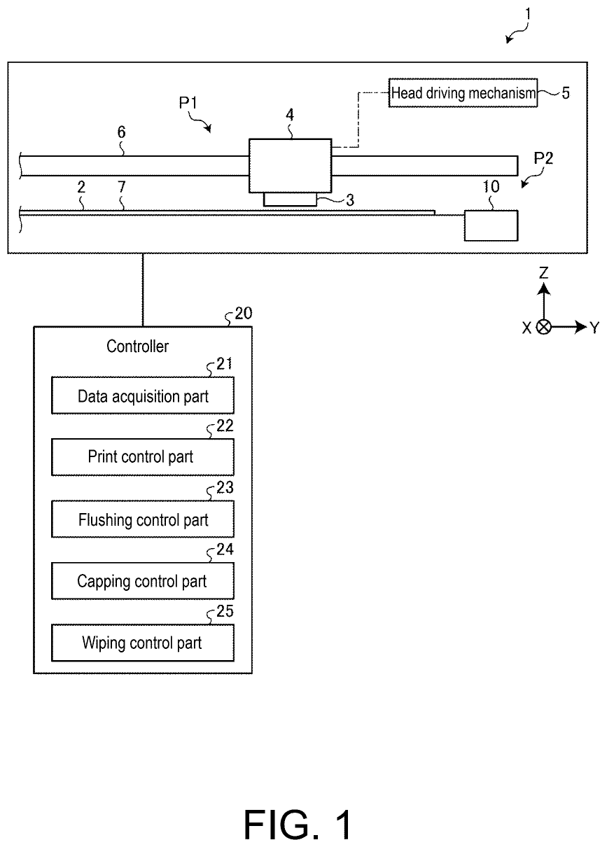

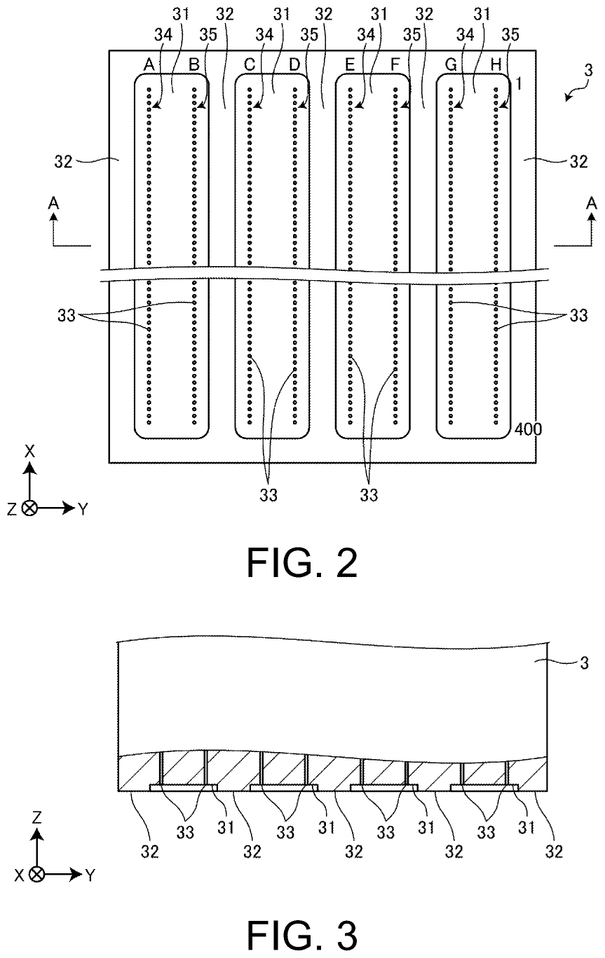

FIG. 1 is a schematic configuration diagram of an inkjet printer according to an embodiment of the present invention. FIG. 2 is a plan view illustrating an example of a nozzle surface of a jetting head illustrated in FIG. 1. FIG. 3 is a partial cross-sectional view taken along line A-A of FIG. 2.

An inkjet printer 1 (hereinafter referred to as a printer 1) according to the present embodiment is, for example, a professional-quality inkjet printer, and performs printing on the recording medium 2 such as paper by performing ink jetting (ejecting). As illustrated in FIG. 1, the printer 1 includes a jetting head 3 that performs ink jetting toward the recording medium 2, a carriage 4 on which the jetting head 3 is mounted, a head driving mechanism 5 that causes the jetting head 3 to reciprocate together with the carriage 4 in a main scanning direction (Y direction), a guide rail 6 that guides the jetting head 3 together with the carriage 4 in the main scanning direction, a platen 7 on which the recording medium 2 is placed at the time of printing, and a medium feeding mechanism (not illustrated) that feeds the recording medium 2 placed on the platen 7 in a sub scanning direction (X direction) orthogonal to a vertical direction and the main scanning direction.

As illustrated in FIG. 2, the jetting head 3 has four nozzle surfaces 31 on an undersurface facing the platen 7 (FIG. 1), and a guard plate 32 is disposed around the nozzle surfaces 31. The four nozzle surfaces 31 have respective colors of magenta, yellow, cyan, and black, for example. The nozzle surface 31 is formed in a substantially rectangular shape extending to be elongated in the sub scanning direction (X direction), and the four nozzle surfaces 31 are arranged side by side in the main scanning direction (Y direction). Each nozzle surface 31 is formed to have a plurality of nozzle holes 33 through which ink jets downward. The jetting head 3 includes a piezoelectric element (not illustrated) that causes ink to jet from all of the plurality of nozzle holes 33.

In the present embodiment, in each nozzle surface 31, two nozzle rows are formed side by side in the Y direction, each nozzle row having a plurality of (400) nozzle holes 33 arranged in the sub scanning direction (X direction) at a predetermined pitch (for example, 84.6 μm pitch (300 dpi)). That is, the jetting head 3 has a configuration in which a plurality of (eight) nozzle rows are arranged in the main scanning direction (Y direction), the plurality of nozzle rows having the plurality of nozzle holes 33 arranged in the sub scanning direction (X direction) orthogonal to the main scanning direction (Y direction) in which the jetting head 3 moves. In the example of FIG. 2, one nozzle row (on the left side in FIG. 2) in each nozzle surface 31 is referred to as a first nozzle row 34, and the other nozzle row (on the right side in FIG. 2) is referred to as a second nozzle row 35. In addition, in each of the first nozzle row 34 and the second nozzle row 35, the nozzle hole 33 at one end (upper end in FIG. 2) is numbered 1, and the nozzle hole 33 at the other end (lower end in FIG. 2) is numbered 400. In addition, in a case where the eight nozzle rows formed in the four nozzle surfaces 31 are distinguished, the nozzle rows are sequentially denoted by A to H from the nozzle row on the left side toward the right side in FIG. 2 for convenience. In this case, the nozzle rows A, C, E, and G are the first nozzle rows 34, and the nozzle rows B, D, F, and H are the second nozzle rows 35.

As illustrated in FIG. 3, the guard plate 32 is formed to project downward (-Z direction) from the nozzle surfaces 31. The guard plate 32 protects the nozzle surfaces 31, and prevents, for example, a cap 11 or the like to be described below from being brought into direct contact with the nozzle surface 31.

As illustrated in FIG. 1, the jetting head 3 is mounted on the carriage 4. The carriage 4 and the jetting head 3 are positioned above the recording medium 2 placed on the platen 7 at the time of printing. During printing, the jetting head 3 moves over the platen 7 in the main scanning direction by the head driving mechanism 5. In the present embodiment, the position of the jetting head 3 over the platen 7 is referred to as a printing position P1. The printing position P1 is a position where the jetting head 3 is disposed at the time of printing, and has a width in the main scanning direction. The width of the printing position P1 is wider than a width of the recording medium 2 in the main scanning direction. At the printing position P1, the jetting head 3 performs printing on the recording medium 2 based on acquired print data.

In addition, the printer 1 includes a cleaning mechanism 10 that cleans the nozzle surfaces 31 of the jetting head 3 so as not to cause a defect such as clogging in the nozzle holes 33, and a controller 20 that controls the entire printer 1 including the cleaning mechanism 10. In the example of FIG. 1, the cleaning mechanism 10 is provided in the vicinity of one end portion (a right end portion in FIG. 1) of the printer 1, and the jetting head 3 is movable above the cleaning mechanism 10 by the head driving mechanism 5. In the present embodiment, a position of the jetting head 3 on the cleaning mechanism 10 is referred to as a standby position P2. The head driving mechanism 5 moves the jetting head 3 to the standby position P2 and the printing position P1 above the platen 7. At this standby position P2, the cleaning mechanism 10 cleans the nozzle surfaces 31 of the jetting head 3 in a timely manner.

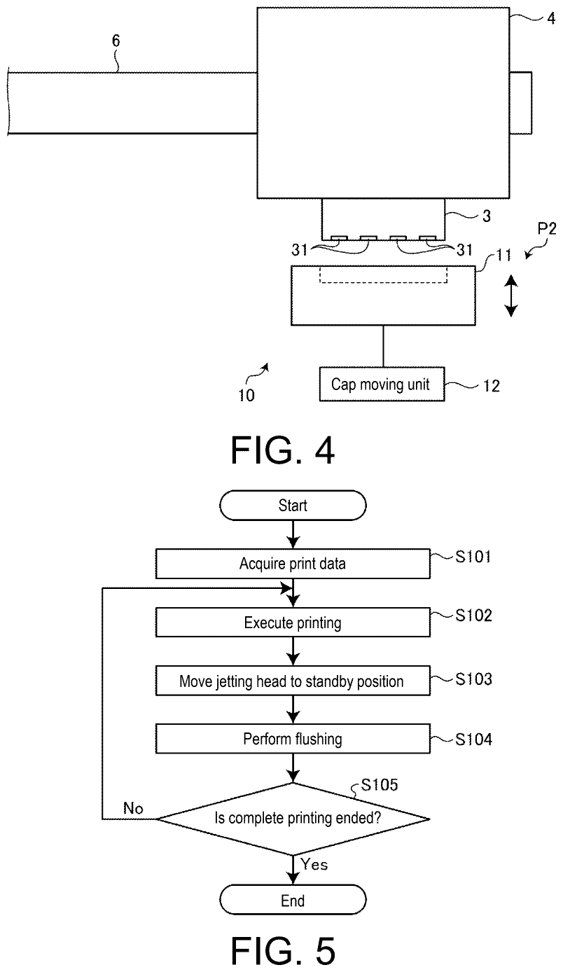

FIG. 4 is a schematic diagram illustrating an example of a cleaning mechanism. As illustrated in FIG. 4, the cleaning mechanism 10 includes the cap 11, a cap moving unit 12, and a wiper unit (not illustrated). The cap 11 can be attached to the nozzle surfaces 31 of the jetting head 3 in a case where the jetting head 3 is positioned at the standby position P2. The cap 11 has a bottomed box shape with an open upper portion, and is made of, for example, rubber or the like. An upper opening of the cap 11 is configured to be attached to an outer peripheral portion of the jetting head 3.

The cap moving unit 12 attaches or separates the cap 11 on or from the nozzle surfaces 31 of the jetting head 3. The cap moving unit 12 supports the cap 11 to be movable in the vertical direction (Z direction). The cap moving unit 12 attaches the cap 11 to the jetting head 3 by raising the cap 11, and detaches the cap 11 from the jetting head 3 by lowering the cap 11. The cap moving unit 12 only needs to support the cap 11 to be raisable or lowerable, and can include, for example, a ball screw and a motor.

The wiper unit wipes and cleans the nozzle surfaces 31 of the jetting head 3, and is provided, for example, between the printing position P1 and the standby position P2. The wiper unit can be configured to clean the nozzle surfaces 31 by causing a wiping plate made of, for example, rubber or the like to abut the undersurface of the jetting head 3, or can be configured to clean the nozzle surfaces 31 by wiping the undersurface of the jetting head 3 with a wiping member made of, for example, nonwoven fabric or the like. In addition, the cleaning mechanism 10 can include a suction unit (not illustrated) that periodically sucks and discharges ink accumulated in the cap 11 to the outside.

As illustrated in FIG. 1, the controller 20 includes a data acquisition part 21, a print control part 22, a flushing control part 23, a capping control part 24, and a wiping control part 25. The controller 20 is, for example, a microcomputer, and includes, for example, an interface (I/F) that receives print data or the like from an external instrument, a central processing unit (CPU) that executes a command of a control program, a read only memory (ROM) that stores a program executed by the CPU, a random access memory (RAM) that is used as a working area in which the program is loaded, and a storage device such as a memory that stores the program and various types of data.

The data acquisition part 21 is connected to an external instrument (not illustrated) as a device that stores print data, and sequentially acquires the print data from the external instrument. The printer 1 executes printing based on the print data sequentially acquired by the data acquisition part 21.

The print control part 22 controls each unit to perform printing. The print control part 22 executes printing based on the acquired print data. The print control part 22 controls the head driving mechanism 5 to dispose the jetting head 3 at the printing position P1, and performs ink jetting from each nozzle hole 33 of the jetting head 3 to the recording medium 2 to perform printing.

The flushing control part 23 controls each unit to perform flushing during printing or during printing standby. The flushing is an operation of moving the jetting head 3 to the standby position P2 periodically (for example, every time reciprocating or scanning is performed by the jetting head 3) during printing, and performing ink jetting from the nozzle holes 33 at a flushing position, for example, above the cap 11. The flushing control part 23 performs flushing before the start of printing (during printing standby) and during printing, for example.

The capping control part 24 controls each unit to attach and detach the cap 11 to and from the jetting head 3. After the printing is ended, the capping control part 24 moves the jetting head 3 to the standby position P2 and operates the cap moving unit 12 to attach the cap 11 to the jetting head 3. In addition, the capping control part 24 operates the cap moving unit 12 before the start of printing to detach the cap 11 from the jetting head 3.

The wiping control part 25 controls each unit to perform wiping. The wiping is work of wiping the nozzle surfaces 31 of the jetting head 3 by a wiper mechanism (not illustrated). The wiping control part 25 performs wiping at the time of, for example, cleaning or periodic maintenance during printing. In addition, the wiping control part 25 may execute wiping, as appropriate, when a wiping instruction is manually issued.

In the flushing operation described above, ink simultaneously jets from all the nozzle holes 33 of the jetting head 3 toward the cap 11. Therefore, strong turbulence may occur between the ink droplets jetting from the adjacent nozzle holes 33, minute ink droplets referred to as mist may adhere to the nozzle surfaces 31, and a printing defect of an image may occur. In particular, as in the present embodiment, in a case where a pitch between the nozzle holes 33 is set to a predetermined pitch (for example, 84.6 μm pitch (300 dpi)), there is a high possibility of occurrence of the printing defect of an image. Therefore, in the present embodiment, the plurality of nozzle holes 33 in the nozzle rows are divided into a plurality of groups in advance, and the flushing operation is sequentially executed for each group, thereby reducing adhesion of minute ink to the nozzle surfaces 31 or the like, and preventing the printing defect of an image

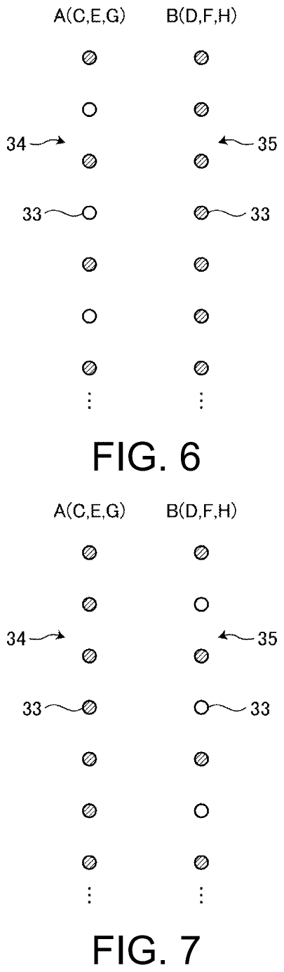

Next, a method for controlling the jetting head 3 according to the present embodiment will be described. FIG. 5 is a flowchart illustrating an operation procedure of a flushing method of the jetting head. FIGS. 6 to 9 are views schematically illustrating whether jetting is performed from the nozzle holes in the flushing operation. In FIGS. 6 to 9, some of the nozzle holes 33 in the first nozzle rows 34 (A, C, E, and G) and the second nozzle rows 35 (B, D, F, and H) are enlarged and illustrated, and the nozzle holes 33 that do not perform jetting are illustrated by hatching. In the following description, the flushing during printing is performed every time reciprocating or scanning is performed (the jetting head 3 reciprocates). In addition, the plurality of nozzle holes 33 are divided into the plurality of groups in advance.

As illustrated in FIG. 5, the controller 20 causes the data acquisition part 21 to acquire the print data from an external instrument (step S101). In the present embodiment, the print data is sequentially transmitted from the external instrument, and the data acquisition part 21 sequentially acquires the transmitted print data.

The controller 20 causes the print control part 22 to sequentially execute printing based on the acquired print data (step S102). Specifically, the print control part 22 moves the jetting head 3 to the printing position P1 and performs reciprocating once or scanning once in the main scanning direction (Y direction) while the jetting head is positioned at the printing position P1. In this case, the print control part 22 causes the ink to jet to the recording medium 2 in synchronization with the movement of the jetting head 3. By this operation, printing for one line is performed on the recording medium 2. Then, the printer 1 transports the recording medium 2 in the sub scanning direction (X direction) by a medium feeding mechanism (not illustrated). In the present embodiment, printing is executed by repeating the printing for one line and transport of the recording medium 2.

The controller 20 moves the jetting head 3 to the standby position P2 by the head driving mechanism 5 (step S103). In the present embodiment, the jetting head 3 is moved to the standby position P2 every time reciprocating or scanning is performed, that is, every time the printing for one line is performed, and the flushing operation to be described below is executed.

Subsequently, the controller 20 causes the flushing control part 23 to perform flushing of the jetting head 3 (step S104). This flushing operation is performed in combination with the printing operation and setting described above. After the jetting head 3 moves to the standby position P2, the flushing control part 23 causes ink to jet into the cap 11 at the standby position P2.

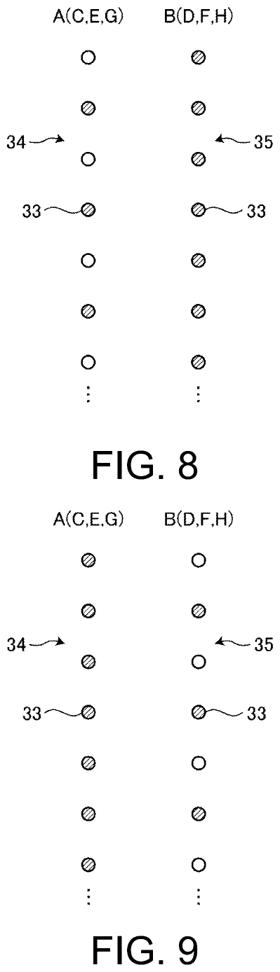

As described above, the plurality of nozzle holes 33 are divided into a plurality of groups in advance (grouping step). The flushing control part 23 sequentially executes, for each group, a flushing operation of the ink jetting to the cap 11 from all of the plurality of the nozzle holes 33 belonging to the groups grouped in advance. Specifically, in the first nozzle rows 34 (A, C, E, and G) and the second nozzle rows 35 (B, D, F, and H), a group including every other (every certain number of) nozzle hole 33 is defined. That is, in the first nozzle rows 34 (A, C, E, and G), a first group in which the numbers of the nozzle holes are even numbers (2, 4, ...) and a second group in which the numbers of the nozzle holes are odd numbers (1, 3, ...) are defined. In addition, in the second nozzle row 35 (B, D, F, and H), a third group in which the numbers of the nozzle holes are even numbers (2, 4, ...) and a fourth group in which the numbers of the nozzle holes are odd numbers (1, 3, ...) are defined. As described above, in the present embodiment, the plurality of nozzle holes 33 are grouped into four groups in advance, and the flushing is sequentially executed for each group. For example, as illustrated in FIG. 6, the nozzle holes 33 having the even numbers in the first nozzle rows 34 (A, C, E, and G) included in the first group are flushed. Subsequently, as illustrated in FIG. 7, the nozzle holes 33 having the even numbers in the second nozzle rows 35 (B, D, F, and H) included in the third group are flushed. Subsequently, as illustrated in FIG. 8, the nozzle holes 33 having the even odd numbers in the first nozzle rows 34 (A, C, E, and G) included in the second group are flushed. Finally, as illustrated in FIG. 9, the nozzle holes 33 having the odd numbers in the second nozzle rows 35 (B, D, F, and H) included in the fourth group are flushed.

In this configuration, the density of the nozzle holes 33 to be flushed is reduced with respect to the plurality of nozzle holes 33. Further, the nozzle holes 33 adjacent in the main scanning direction (Y direction) and the sub scanning direction (X direction) are prevented from being simultaneously flushed. Therefore, the occurrence of the turbulence between ink droplets jetting from the adjacent nozzle holes 33 can be reduced, and fine ink droplets can be prevented from adhering to the nozzle surfaces 31 or the like. Hence, a printing defect of an image can be prevented as appropriate. In particular, in this configuration, it was found that, of the plurality of nozzle rows, the amount of ink adhering to the nozzle surfaces 31 can be reduced in a nozzle row (for example, C, D, E, or F) on the central side in the main scanning direction as compared with a nozzle row (for example, A, B, G, or H) on an end side in the main scanning direction. As described above, in the above-described flushing operation, a higher effect can be achieved in the nozzle row (for example, C, D, E, or F) on the center side in the main scanning direction.

Next, the controller 20 determines whether the printing has been completely ended (step S105). Specifically, the print control part 22 determines whether the printing has been executed based on all the acquired items of print data. In this determination, in a case where the printing has not been completely ended (step S105; No), the process returns to step S102. In addition, in a case where the printing has been completely ended (step S105; Yes), the process is ended.

In the present embodiment, the flushing operation of all the nozzle holes 33 is executed each time the reciprocating or the scanning is performed, but the present invention is not limited thereto, and the frequency may be changed depending on, for example, an ink drying speed. For example, in a case where the ink to be used is not dried earlier than a predetermined specified time, the flushing of the nozzle holes 33 having the even numbers of the first nozzle rows 34 (A, C, E, and G) included in the first group as illustrated in FIG. 6 and the flushing of the nozzle holes 33 having the even numbers of the second nozzle rows 35 (B, D, F, and H) included in the third group as illustrated in FIG. 7 are performed every first reciprocating or every first scanning. Then, the flushing of the nozzle holes 33 having the odd numbers of the first nozzle rows 34 (A, C, E, and G) included in the second group as illustrated in FIG. 8 and the flushing of the nozzle holes 33 having the odd numbers of the second nozzle rows 35 (B, D, F, and H) included in the fourth group as illustrated in FIG. 9 are performed every second reciprocating or every second scanning. In this configuration, as described above, the occurrence of the turbulence between ink droplets jetting from the adjacent nozzle holes 33 can be reduced, and fine ink droplets can be prevented from adhering to the nozzle surfaces 31 or the like. Hence, a printing defect of an image can be prevented as appropriate. Further, since a time required for flushing each time the reciprocating or the scanning is performed can be reduced, the printing efficiency can be improved.

As described above, the printer 1 according to the present embodiment includes the jetting head 3 that performs the ink jetting from the plurality of nozzle holes 33 formed in the nozzle surface 31, the cap 11 that is attachable on the nozzle surface 31 of the jetting head 3, the head driving mechanism 5 that moves the jetting head 3 to the standby position P2 where the cap 11 is detachable and the printing position P1 where the printing is performed by acquiring the print data, and the flushing control part 23 that sequentially executes, for each group, the flushing operation of ink jetting to the cap 11 from all of the plurality of the nozzle holes 33 belonging to groups grouped in advance in the case where the jetting head 3 moves to the standby position P2. According to this configuration, the density of the nozzle holes 33 to be flushed is reduced with respect to the plurality of nozzle holes 33. Consequently, the occurrence of the turbulence between ink droplets jetting from the nozzle holes 33 is reduced, and fine ink droplets are prevented from adhering to the nozzle surfaces 31. Hence, a printing defect of an image can be prevented as appropriate.

In addition, in the printer 1 according to the present embodiment, the jetting head 3 has the configuration in which the plurality of nozzle rows are arranged in the main scanning direction, the plurality of nozzle rows having the plurality of nozzle holes 33 arranged in the sub scanning direction (X direction) orthogonal to the main scanning direction (Y direction) in which the jetting head 3 moves, and the flushing control part 23 defines the group which includes every certain number of nozzle holes 33 in at least one nozzle row, and executes the flushing operation for each group. According to this configuration, in at least one nozzle row, the nozzle holes 33 adjacent in the sub scanning direction (X direction) are prevented from being simultaneously flushed. Consequently, the occurrence of the turbulence between ink droplets jetting from the nozzle holes 33 adjacent in the sub scanning direction (Y direction) is reduced, and fine ink droplets are prevented from adhering to the nozzle surfaces 31. Hence, a printing defect of an image can be prevented as appropriate.

In addition, in the printer 1 according to the present embodiment, the jetting head 3 has the configuration in which the plurality of nozzle rows are arranged in the main scanning direction, the plurality of nozzle rows 33 having the plurality of nozzle holes arranged in the sub scanning direction (X direction) orthogonal to the main scanning direction (Y direction) in which the jetting head 3 moves, and the flushing control part 23 groups the individual nozzle holes adjacent to each other in the main scanning direction (Y direction) or the sub scanning direction (X direction) into separate groups. Consequently, the nozzle holes 33 adjacent in the main scanning direction (Y direction) or the sub scanning direction (X direction) are prevented from being simultaneously flushed with respect to one nozzle hole 33, so that the occurrence of the turbulence between the ink droplets jetting from the nozzle holes 33 adjacent in the main scanning direction (Y direction) and the sub scanning direction (X direction) is reduced, and minute ink droplets are prevented from adhering to the nozzle surfaces 31. Hence, a printing defect of an image can be prevented as appropriate.

The technical scope of the present invention is not limited to the embodiments, and can be modified, as appropriate, without departing from the gist of the present invention.

### REFERENCE SIGNS LIST

1 Printer (inkjet printer)
2 Recording medium
3 Jetting head
5 Head driving mechanism
10 Cleaning mechanism
11 Cap
12 Cap moving unit
20 Controller
21 Data acquisition part
22 Print control part
23 Flushing control part
24 Capping control part
25 Wiping control part
31 Nozzle surface
33 Nozzle hole
34 First nozzle row
35 Second nozzle row
P1 Printing position
P2 Standby position

1. An inkjet printer comprising:
a jetting head that performs ink jetting from a plurality of nozzle holes formed in a nozzle surface;
a cap that is attachable on the nozzle surface of the jetting head;
a head driving mechanism that moves the jetting head to a standby position where the cap is detachable and a printing position where printing is performed by acquiring print data; and
a flushing control part that sequentially executes, for each group, a flushing operation of ink jetting to the cap from all of a plurality of the nozzle holes belonging to groups grouped in advance in a case where the jetting head moves to the standby position.

2. The inkjet printer as set forth in claim 1, wherein
the jetting head has a configuration in which a plurality of nozzle rows are arranged in a main scanning direction, the plurality of nozzle rows having the plurality of nozzle holes arranged in a sub scanning direction orthogonal to the main scanning direction in which the jetting head moves, and
the flushing control part defines each of the groups which includes every certain number of nozzle holes in at least one nozzle row, and executes a flushing operation for each group.

3. The inkjet printer as set forth in claim 1, wherein
the jetting head has a configuration in which a plurality of nozzle rows are arranged in a main scanning direction, the plurality of nozzle rows having the plurality of nozzle holes arranged in a sub scanning direction orthogonal to the main scanning direction in which the jetting head moves, and
the flushing control part groups the individual nozzle holes adjacent to each other in the main scanning direction or the sub scanning direction into separate groups.

4. A method for controlling a jetting head in an inkjet printer including a jetting head that performs ink jetting from a plurality of nozzle holes formed in a nozzle surface, a cap that is attachable on the nozzle surface of the jetting head, and a head driving mechanism that moves the jetting head to a standby position where the cap is detachable and a printing position where printing is performed by acquiring print data, the method comprising:
a moving step of moving the jetting head to the standby position; and
a flushing step of sequentially executing, for each group, a flushing operation of ink jetting to the cap from all of a plurality of the nozzle holes belonging to groups grouped in advance.

5. The method for controlling a jetting head as set forth in claim 4, wherein
the inkjet printer further includes a flushing control part, and
the jetting head has a configuration in which a plurality of nozzle rows are arranged in a main scanning direction, the plurality of nozzle rows having the plurality of nozzle holes arranged in a sub scanning direction orthogonal to the main scanning direction in which the jetting head moves.

6. The method for controlling a jetting head as set forth in claim 5, further comprising a step of grouping the individual nozzle holes adjacent to each other in the main scanning direction or the sub scanning direction into separate groups by the flushing control part,
wherein, in the flushing step, jetting is not performed at the same timing from the nozzle holes adjacent in the main scanning direction or the sub scanning direction.
